(19) United States
(12) Patent Application Publication
(10) Pub. No.: US 2010/0156799 A1
(43) Pub. Date: Jun. 24, 2010

(54) Portable Terminal Device and Input Mode Control Method

(75) Inventor: Chihiro Miyazawa, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/377,112

(22) PCT Filed: Aug. 10, 2007
(86) PCT No.: PCT/JP2007/065770

§ 371 Date: Feb. 10, 2009

(30) Foreign Application Priority Data
Aug. 11, 2006 (JP) 2006-220493

(51) Int. Cl. G06F 3/02

(52) U.S. Cl. 345/169

(57) ABSTRACT

A portable terminal device in which a preset input mode can be forcibly return to by a simple operation and the user convenience and operability can be improved and its input mode control method. When the operation of a specific key is detected or the operating time of the specific key is monitored and it is detected that the specific key is continuously operated for a predetermined time or more, a control unit 16 forcibly returns the mode to the preset input mode and displays input characters or symbols in a preset language or language effective in the area to which the terminal device belongs.

### TECHNICAL FIELD

The present invention relates to a mobile phone or other portable terminal device having the function of inputting a plurality of types of characters or symbols assigned to a single key according to an input mode and an input mode control method of the same.

### BACKGROUND ART

The improvement in the performances of mobile phones has been remarkable. Along with their diversification, almost all models of mobile phones on the market now mount e-mail transmission/reception functions.

Usually, in a mobile phone, due to the restriction in the number of keys which can be mounted, each key is assigned a plurality of types of characters such as alphanumeric characters, Japanese kana characters, and alpha symbols. Further, in a mobile phone, the input mode is determined by operation (for example depression) of a separately assigned shift key. According to the input mode, one type of character assigned to a key becomes effective.

Further, the mobile phone transfers the input characters to a character processing control unit which, for example, prepares and sends an e-mail.

Note that, in mobile phones actually used, as input modes, the Japanese kana kanji character input mode, em Japanese katakana character input mode, one-byte Japanese katakana character input mode, em English character input mode, one-byte English character input mode, numeral input mode, symbol input mode, etc. are employed.

Many methods of character input have been proposed for the mobile phones described above.

For example, the method of switching input modes by a toggle operation by a specific key or selection from a list display (see for example Patent Document 1) or a method of monitoring switching between capital letters and small letters of the alphabet according to a depression time of a key (see for example Patent Document 2) is known.
Patent Document 1: Japanese Patent No. 3652989
Patent Document 2: Japanese Patent Publication (A) No. 2002-518721

### DISCLOSURE OF THE INVENTION

### Problem to be Solved by the Invention

In the technique disclosed in Patent Document 1 described above, when using a toggle operation to return from a symbol input, em English alphabet input, or other input mode to the Japanese kana kanji character input mode (hereinafter referred to as a “base input mode”) set as a default and with a relatively high frequency of use, the following switching operation is required.

Namely, switching from the Japanese kana kanji character input mode to the em Japanese katakana character input mode, switching from the em Japanese katakana character input mode to the one-byte Japanese katakana character input mode, switching from the one-byte Japanese katakana character input mode to the em English character input mode, switching from the em English character input mode to the one-byte English character input mode, switching from the one-byte English character input mode to the numeral input mode, switching from the numeral input mode to the symbol input mode, and switching from the symbol input mode to the Japanese kana kanji character input mode, i.e., seven switching operations, are required.

Further, even by the list display, it is necessary to display, a list first and select and change the default input mode by a cross key or the like, therefore three operations of “display”, “select”, and “decide” are required.

Accordingly, in both the methods using the toggle operation and list display described above, a long time is required for return to the high frequency of use base input mode and a considerable number of key operations are required, therefore the user convenience was poor and the operability was difficult.

On the other hand, Patent Document 2 discloses the method of switching between capital letters and small letters of the alphabet according to the depression time of a key, but there is no disclosure of a technique relating to improvement of the user convenience by forced return from another input mode other than the alphabet to the base input mode.

The present invention provides a portable terminal device in which forced return to a preset input mode is possible with a simple operation and the user convenience and operability can be improved and an input mode control method of the same.

### Means for Solving the Problem

A portable terminal device of a first aspect of the present invention has a specific key, an operation input unit in which a plurality of types of characters or symbols are assigned to each key and inputting characters or symbols in accordance with the input mode, and an input mode control unit which forcibly returns to a preset input mode when detecting that the specific key is operated.

A portable terminal device of a second aspect of the present invention has a specific key, an operation input unit in which a plurality of types of characters or symbols are assigned to each key and inputting characters or symbols in accordance with the input mode, a time monitoring unit monitoring an operating time of the specific key, and an input mode control unit which forcibly returns to a preset input mode when detecting by the time monitoring unit that the specific key is continuously operated for a predetermined time or more.

Preferably, the terminal device further has a display unit displaying input characters or language, and the input mode control unit, when detecting that the specific key is operated or detecting that the specific key is continuously operated for a predetermined time or more, reads out a preset language and decides to return to the input mode, compares the input mode which was effective immediately before the decision and the decided input mode, changes to the decided input mode according to the comparison result, and displays the characters or symbols input in accordance with the input mode on the display unit based on the set language.

Preferably, the terminal device further has a communication unit capable of communicating with a base station, and the input mode control unit, when detecting that the specific key is operated or detecting that the specific key is continuously operated for a predetermined time or more, identifies an area to which the terminal device belongs from information acquired from the base station and decides to return to the input mode based on the language effective in the area.

Preferably, the terminal device has a user interface providing unit displaying a message for variable setting the predetermined time to prompt the user to input the setting, obtaining the setting input by the user, and reflecting it in the monitoring of the time of depression of the specific key.

A portable terminal device of a third aspect of the present invention has a specific key, an operation input unit in which a plurality of types of characters or symbols are assigned to each key and inputting characters or symbols in accordance with the input mode, a control unit which monitors the operation of the specific key or the operating time of the specific key and forcibly returns to a preset input mode when detecting the operation of the specific key or detecting that the specific key is continuously operated for a predetermined time or more, and a display unit displaying the input characters or language, wherein the control unit displays the input characters or symbols in a preset language or a language effective in the area to which the terminal device belongs.

Preferably, the control unit, when detecting the operation of the specific key or detecting that the specific key is continuously operated for a predetermined time or more, reads out a preset language and decides return to the input mode, compares the input mode which was effective immediately before the decision and the decided input mode, changes to the decided input mode according to the comparison result, and displays the characters or symbols input in accordance with the input mode on the display unit based on the set language.

Preferably, the terminal device further has a communication unit capable of communicating with a base station, and the control unit, when detecting that the specific key is operated or detecting that the specific key is continuously operated for a predetermined time or more, identifies an area to which the terminal device belongs from information acquired from the base station, decides to return to the input mode based on the language effective in the area, and displays the input characters or symbols on the display unit by the language effective in the area to which the terminal device belongs.

A fourth aspect of the present invention is an input mode control method of a portable terminal device inputting a plurality of types of characters or symbols assigned to each key according to an input mode, having a first step of monitoring the operation of a specific key or an operating time of the specific key and forcibly returning to a preset input mode when detecting the operation of the specific key or detecting that the specific key is continuously operated for a predetermined time or more and a second step of displaying the input characters or symbols in a preset language or a language effective in the area to which the terminal device belongs.

### EFFECT OF THE INVENTION

According to the present invention, it becomes possible for a user to forcibly return to a preset input mode by a simple operation and it becomes possible to improve the user convenience and operability.

### BRIEF DESCRIPTION OF THE DRAWINGS

FIG. 1 is a view of the system configuration showing a wireless communication system to which a mobile phone constituting a portable terminal device according to an embodiment of the present invention is applied.

FIG. 2 is a block diagram of the configuration showing a mobile phone constituting a portable terminal device according to an embodiment of the present invention.

FIG. 3 is a block diagram showing a concrete example of the configuration of a control unit according to the present embodiment.

FIG. 4 is a perspective view showing an example of the configuration of the appearance of a mobile phone constituting a portable terminal device according to an embodiment of the present invention.

FIG. 5 is a flow chart showing a first example of the operation of a mobile phone constituting a portable terminal device according to an embodiment of the present invention.

FIG. 6 is a flow chart showing a second example of operation of a mobile phone constituting a portable terminal device according to an embodiment of the present invention.

FIG. 7 is a flow chart showing a third example of operation of a mobile phone constituting a portable terminal device according to an embodiment of the present invention.

FIG. 8 is a flow chart showing a fourth example of operation of a mobile phone constituting a portable terminal device according to an embodiment of the present invention.

### BEST MODE FOR CARRYING OUT THE INVENTION

Below, an explanation will be given of embodiments of the present invention with reference to the attached drawings.

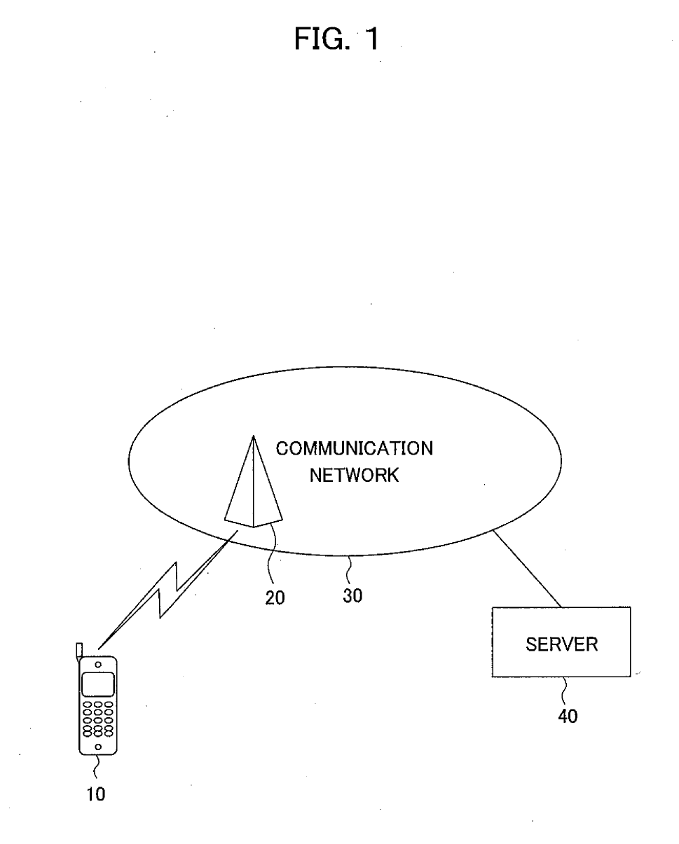

FIG. 1 is a view of the system configuration showing a wireless communication system to which a portable terminal device according to an embodiment of the present invention is applied.

A portable terminal device 10 according to the present embodiment, as shown in FIG. 1, has the function of using a wireless communication unit to access a base station 20 to place a request via a communication network 30 to a server 40 for desired data and displaying Web data and other information acquired via the base station 20 in response to the request at a display unit.

Below, in the present embodiment, the explanation will be given illustrating a mobile phone as the portable terminal device. Note that, here, in the present embodiment, while the explanation is given by illustrating a mobile phone as the portable terminal device, the present invention can also be applied to a PDA or other portable terminal device.

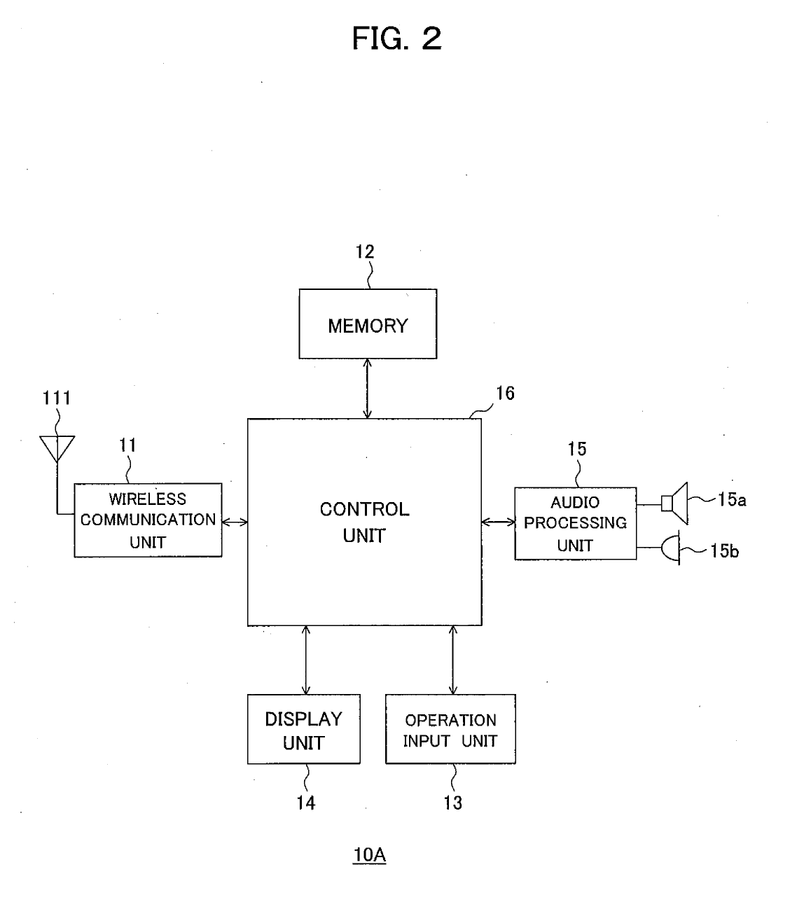

FIG. 2 is a block diagram of the configuration showing a mobile phone constituting a portable terminal device according to an embodiment of the present invention.

A mobile phone 10A constituting a portable terminal device according to the present embodiment, as shown in FIG. 2, has a wireless communication unit 11, a memory 12 constituting the memory unit, an operation input unit 13, a display unit 14, an audio processing unit 15 including a speaker 15a and a microphone 15b, and a control unit 16.

The wireless communication unit 11 engages in wireless communication utilizing radio waves by modulating image data, audio information, e-mails, and other various types of information processed in the control unit 16 and transmitting the same through a transmission/reception antenna 111 to the communication network 30 including the base station 20.

Further, the wireless communication unit 11 receives image data, audio information, e-mails, etc. transmitted from the server 40 via the communication network 30 and base station 20 through the transmission/reception antenna 111, demodulates the received various types of information, and outputs the result to the control unit 16.

The memory 12 includes an EEPROM or other nonvolatile memory and stores a control program for speech and transmission/reception of mail, an Internet browser, message data, an address book in which names and phone numbers are registered, and so on.

The memory 12 stores Japanese, English, and other preset display language information. The display language information stored in this memory 12 is accessed by the control unit 16 and used for deciding for example the base input mode in Japanese or the base input mode in English as will be explained later.

The operation input unit 13 has an end (hangup)/power key, start (call) key, ten-keys etc. corresponding to numerals etc. and supplies the input information from the user to the control unit 16 by the operation of these keys.

The operation input unit 13 of the present embodiment is configured by a group of key switches in which each key is assigned a plurality of types of characters or symbols and inputs characters or symbols to the control unit 16 in accordance with the input mode by the operation of the user.

The display unit 14 has a liquid crystal display device (LCD) or organic EL (electro-luminescent) or other display device and displays, under the control of the control unit 16, for example a phone number input for the speech function and various types of messages, text data, etc. by the operation input unit 13.

The display unit 14, under the control by the control unit 16, displays the characters or symbols input by the operation input unit 13 in the preset language stored in the memory 12 or the language effective in the area to which the terminal belongs.

The audio processing unit 15 has an audio processing circuit and is connected with the speaker 15a for audio output and the microphone 15b for audio input for the speech function.

The audio processing unit 15, in the wireless communication mode, performs predetermined processing to the audio picked up by the microphone 15b and outputs the result to the control unit 16.

The audio processing unit 15 performs predetermined processing on the audio information supplied by the control unit 16 and makes the speaker 15a emit sound.

The control unit 16 is mainly configured by a microcomputer and controls the overall mobile phone 10A.

For example, the control unit 16 performs the control of wireless transmission/reception of various information in the wireless communication unit 11, processing of audio information for the audio processing unit 15, control of display of information to the display unit 14, processing in accordance with the input information of the operation input unit 13, and control of access to the memory 12.

In the wireless communication mode, the control unit 16 can, engage in wireless communications through the wireless communication unit 11 according to a desired communication scheme. The control unit 16 makes the display unit 14 display a standard screen (so-called standby screen) immediately after being powered up. In the wireless communication mode, it is possible to perform a call operation etc. by the operation of the operation input unit 13.

The control unit 16 has the function of detecting when a specific key provided at for example the operation input unit 13 or separately provided is operated (for example, depressed) or monitoring the operation (for example depression) time of the specific key and forcibly returning to the preset input mode when detecting that this specific key is continuously operated (for example depressed) for a predetermined time or more.

Here, a further concrete configuration of the control unit 16 will be explained.

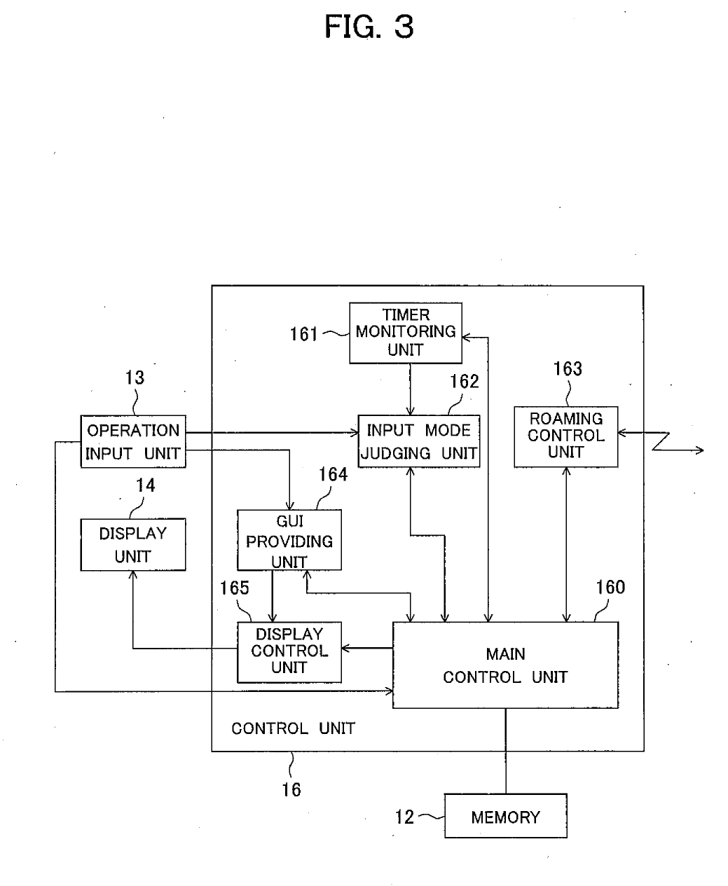

FIG. 3 is a block diagram showing a concrete example of the configuration of the control unit according to the present embodiment. FIG. 3 primarily shows a function unit for forcibly returning to the preset base input mode.

The control unit 16 of FIG. 3 is configured by a main control unit 160, a timer monitoring unit 161, an input mode judging unit 162, a roaming control unit 163, a graphical user interface (GUI) providing unit 164, and a display control unit 165.

The main control unit 160 has an input mode control function forcibly returning to the preset input mode when the timer monitoring unit 161 detects that the specific key is continuously operated (depressed as an example in the following description) for a predetermined time or more.

Note that, in the keys of the operation input unit 13, the specific key is used also as a normal key performing a toggle operation or is assigned to a dedicated key different from the normal keys.

At this time, the timer monitoring unit 161 has a time monitor function of monitoring the depression time of the specific key. Further, the input mode judging unit 162 judges the input mode of the key operation input via the operation input unit 13 and supplies the judgment information to the main control unit 160.

The main control unit 160, further, when detecting that the specific key is continuously depressed for the predetermined time or more, reads out the preset language information from the memory 12 and decides on return to the input mode.

The main control unit 160 compares the input mode which was effective immediately before the decision of return to the input mode and the decided input mode.

The main control unit 160 changes to the decided input mode according to the result of this comparison and displays the input characters or symbols based on the set language by controlling the display control unit 165.

On the other hand, the roaming control unit 163 identifies the area to which the terminal belongs from the information acquired from the base station 20 and supplies the identification information to the main control unit 160. At this time, the main control unit 160 decides to return to the input mode based on the language effective in this identified area.

The GUI providing unit 164, under the control by the main control unit 160, displays a message for variable setting the predetermined time to be set in the timer monitoring unit 161 so as to prompts input by the user of the setting, obtains the setting input by the user, and reflects it in the monitoring of the time of depression of the specific key.

The display control unit 165, under the control by the main control unit 160 or the GUI providing unit 164, converts the generated display information to a display signal and displays it on the display unit 14.

Note that the main control unit 160 is configured by a microcomputer. The microcomputer reads out programs stored in the memory, runs them one after another to controlling peripheral devices including the memory so as to realize a function of “forcibly returning to the preset input mode and displaying the input characters or symbols in the preset language or the language effective in the area to which it belongs when detecting the operation (for example depression operation) of the specific key or detecting that the specific key is continuously depressed for the predetermined time or more by monitoring the depression time of the specific key”.

Here, the “peripheral devices” mean at least one of the timer monitoring unit 161, input mode judging unit 162, roaming control unit 163, GUI providing unit 164, and display control unit 165 and are configured by an LSI independent from the microcomputer. Note that some of the functions accomplished by these configurations may also be partially handled by the microcomputer.

Here, the array of the specific key and other keys will be briefly explained.

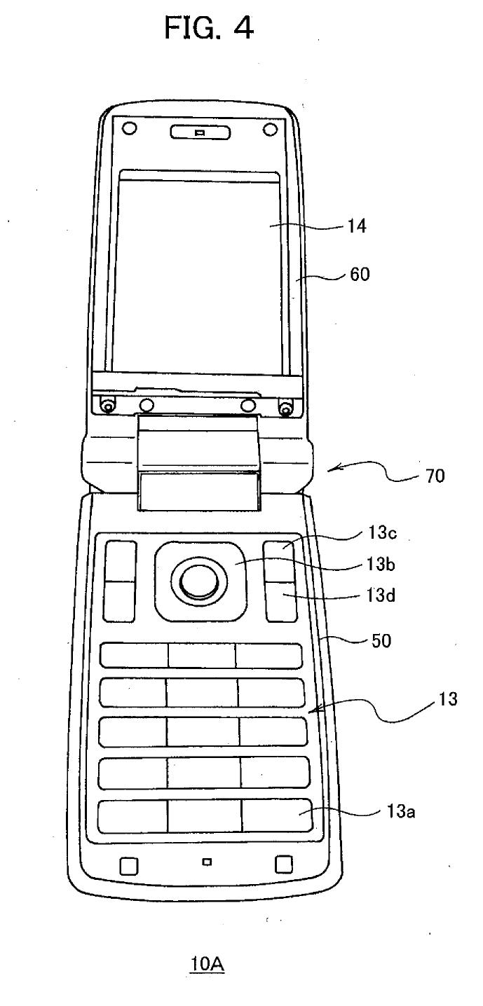

FIG. 4 is a perspective view showing an example of the configuration of the appearance of a mobile phone constituting a portable terminal device according to an embodiment of the present invention. In FIG. 4, the key array is mainly shown.

As shown in FIG. 4, the portable terminal device is configured as a so-called flip-open type mobile phone 10A which is provided with a sender case 50 and a receiver case 60 connected with respect to each other to be able to pivot between an open state and a closed state.

The sender case 50 and the receiver case 60 form a housing of the portable terminal device as a whole by being coupled by a coupling 70 forming the center of opening/closing of their ends with respect to each other.

The sender case 50 is provided with an operation input unit 13 at which are arranged various keys exposed at a front surface S1. Further, the receiver case 60 is provided with the display unit 14.

As the various keys, for example, ten-keys 13a, a cursor key 13b, function keys 13c, etc. are arranged at the operation input unit 13 of the sender case 50.

To each of the ten-keys 13a described above, a plurality of characters relating to Japanese kanji characters, alphanumeric characters, Japanese kana characters, and symbols are assigned.

The effective characters intended by the ten-key units 13a are switched by a toggle operation by an “input mode change key (specific key)” assigned to any of the function keys 13c. This specific key is used in the first example of operation and the third example of operation explained later.

Further, the “base input mode return key (specific key)” shown in the second example of operation and the fourth example of operation is assigned to a dedicated key 13d different from the function key 13c described above.

Note that, this “base input mode return key (specific key)” may be assigned to any of the function keys 13c described above. Further, the “base input mode return key (specific key)” may be assigned to a not shown side key arranged at a side surface S2 of the sender case.

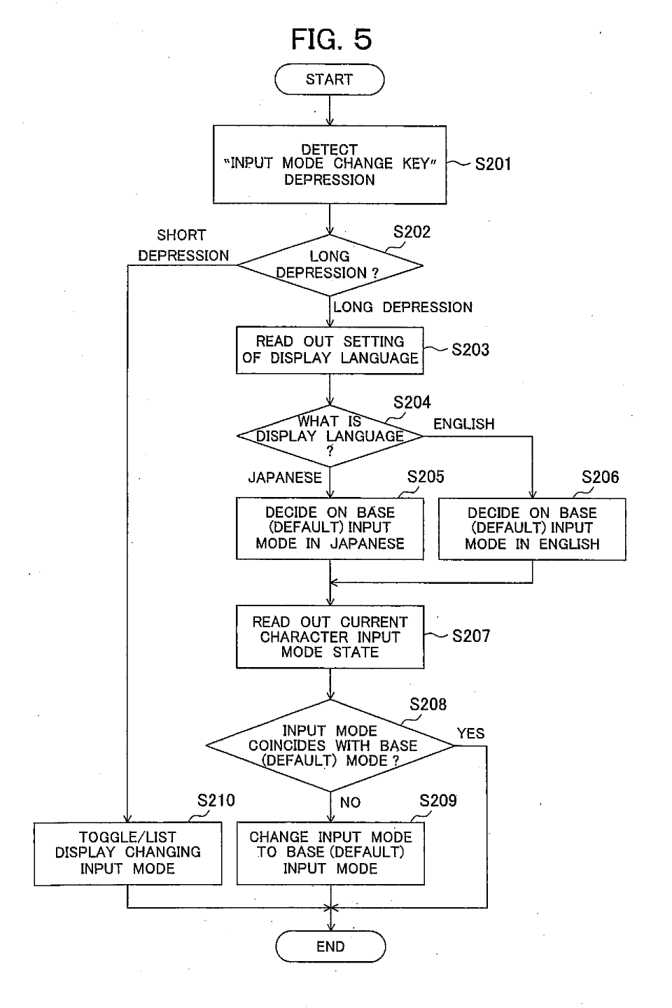

Below, the operation of the mobile phone 10A constituting the portable terminal device having the above configuration will be explained in detail with reference to the flow charts shown in FIG. 5 to FIG. 8 as the first to fourth examples of operation focusing on the input mode control operation.

First Example of Operation

FIG. 5 is a flow chart for explaining the first example of operation of a mobile phone constituting a portable terminal device according to an embodiment of the present invention.

Below, the first example of operation of the mobile phone 10A constituting the portable terminal device according to the embodiment of the present invention will be explained with reference to the flow chart shown in FIG. 5.

First, assume that the “input mode change key” assigned as the specific key and arranged as a key is depressed by the user operating the operation input unit 13 and that the input mode judging unit 162 detects this (step S201). Here, as explained above, the “input mode change key” is also used as a normal key performing a toggle operation.

The main control unit 160 controls the timer monitoring unit 161 and monitors the depression time of the “input mode change key” at this time (step S202). The input mode judging unit 162 judges “long depression” in for example a case of continuous depression for 600 ms or more, while judges “short depression” in a case of not more than 600 ms, and supplies that information to the main control unit 160.

Here, in the case of the judgment of “short depression” (“short depression” at step S202), the main control unit 160 changes the input mode by the toggle operation or the list display where a list is displayed on the display unit 14 (step S210).

On the other hand, in the case of the judgment of “long depression”, the main control unit 160 reads out the initialized display language from the memory 12 (step S203) and judges for example whether it is English or Japanese (step S204). The display modes prepared here are made only English and Japanese, but the language of another country may be included as well.

Here, when it is judged as Japanese (“Japanese” at step S204), the main control unit 160 decides on the base input mode using a Japanese display (step S205), while when it is judged as English (“English” at step S204), decides on the base input mode using an English display (step S206).

Next, the current base input mode becoming effective immediately before the decision of the base input mode is read out (step S207) and is compared with the base input mode decided by the above description (step S208).

When as a result of the comparison here, it is judged they do not coincide (“no” at step S208), the main control unit 160 changes the input mode to the decided base input mode and forcibly returns (step S209). Then, it controls the display control unit 165 and displays the characters or symbols input via the operation input unit 13 on the display unit 14 based on the set language. Note that when it is judged at step S208 that they coincide (“yes” at step S208), the unit does nothing.

According to the first example of operation described above, by measuring the depression time of the “input mode change key” and forcibly returning to the preset base input mode when long depression is detected, improvement of the user convenience can be achieved.

The base input mode can be returned to by one touch in this way, therefore the user is released from stress due to the waiting time and the usage lifetime of the keys themselves can be extended. Further, a portable terminal can be provided in which the texting time is shortened and the display language can be returned to the language at the base input mode and which is excellent in the operability and enables bilingual operation.

Note that although not shown in the flow chart shown in FIG. 5, for the monitoring time (timer value) which becomes the grounds for the judgment of long depression or short depression, i.e., so-called monitoring of the predetermined time, other than the value set by default by the device, a value set by the user is also possible.

Namely, this is accomplished at the time of setting the device environment or at a suitable timing by the control unit 16 controlling the GUI providing unit 164.

Concretely, the GUI providing unit 164 displays a message for setting the timer value initialized at the timer monitoring unit 161 on the display unit 14 so as to prompt the user to input a setting, then obtains the setting input by the user via the operation input unit 13, transfers it to the main control unit 160, and reflects it in the monitoring of the time of depression of the specific key.

Second Example of Operation

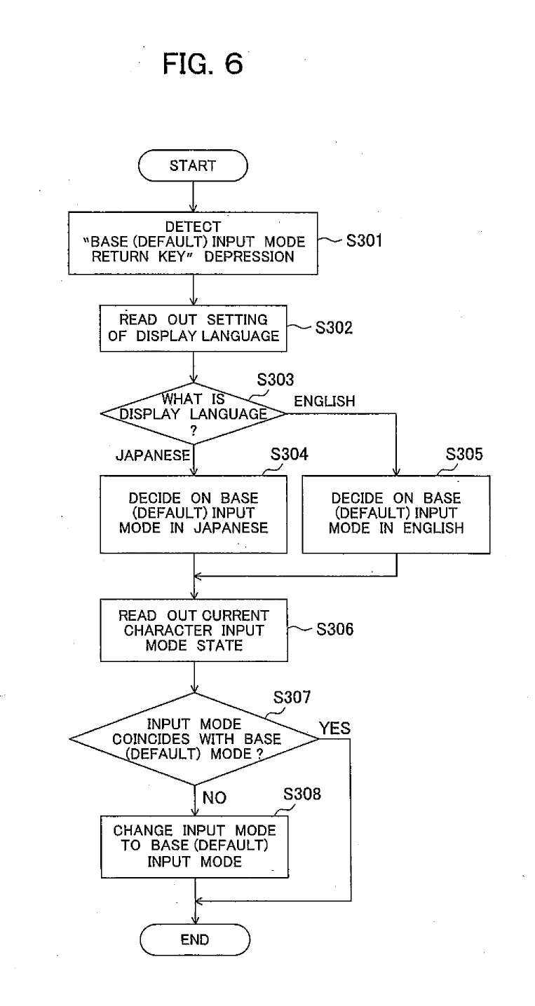

FIG. 6 is a flow chart for explaining a second example of operation of a mobile phone constituting a portable terminal device according to an embodiment of the present invention.

Below, the second example of operation of the mobile phone 10A constituting a portable terminal device according to an embodiment of the present invention will be explained with reference to the flow chart shown in FIG. 6.

First, assume that the “base input mode return key” assigned as the specific key and arranged in the keys is depressed by the user operating the operation input unit 13 and that the input mode judging unit 162 detects this (step S301). Here, as explained above, it is assumed that the “base input mode return key” is newly arranged as a separate dedicated key different from the normal keys performing toggle operations.

On the other hand, the main control unit 160 reads out the initialized display language (step S302) and judges for example whether it is English or Japanese (step S303). Note that the display modes prepared here are made only English and Japanese, but the language of another country may be included as well.

When it is judged as Japanese (“Japanese” at step S303), the main control unit 160 decides on the base input mode using a Japanese display (step S304), while when it is judged as English (“English” at step S303), decides on the base input mode using an English display (step S305).

Next, the main control unit 160 reads out the current input mode becoming effective immediately before the decision of the base input mode (step S306) and compares it with the input mode decided according to the above description (step S307).

Here, when as a result of the comparison here, it is judged that they do not coincide (“no” at step S307), the main control unit 160 changes the input mode to the decided input mode and forcibly returns. Then, the main control unit 160 controls the display control unit 165 and displays the characters or symbols input via the operation input unit 13 on the display unit 14 based on the set language (step S308). Note that when it is judged at step S307 that they coincide (“yes” at step 307), the unit does nothing.

According to the second example of operation described above, by forcibly returning to the preset input mode when the depression of the dedicated “base input mode return key” is detected, the user convenience is improved. Note that when assigned as a dedicated key, the function can be realized by a short depression, therefore the monitoring etc. of the depression time is unnecessary.

Accordingly, the timer monitoring unit 161 shown in FIG. 3 becomes unnecessary, therefore the load of the main control unit 160 is reduced in comparison with the first example of operation.

As described above, the base input mode can be return to by one touch in this way, therefore the user is released from stress due to the waiting time. Further, a portable terminal device can be provided in which the texting time is shortened and the display language can be automatically return to the language at the base input mode and which is excellent in the operability and enables bilingual operation.

Third Example of Operation

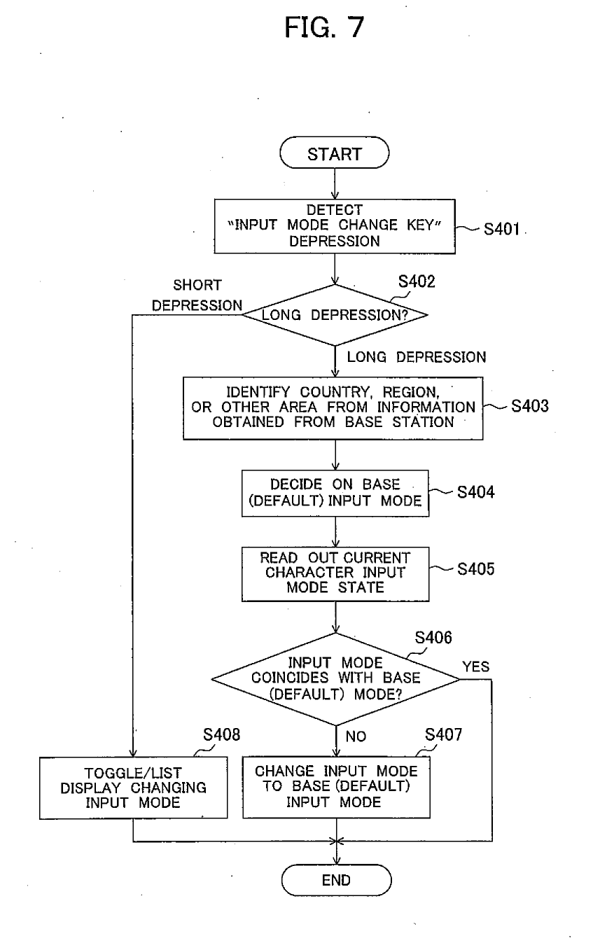

FIG. 7 is a flow chart for explaining a third example of operation of a mobile phone constituting a portable terminal device according to an embodiment of the present invention.

Below, the third example of operation of the mobile phone 10A constituting a portable terminal device according to the embodiment of the present invention will be explained with reference to the flow chart shown in FIG. 7.

First, assume that the “input mode change key” assigned as the specific key and arranged in the keys is depressed by the user operating the operation input unit 13 and that the input mode judging unit 162 detects this (step S401). As described above, it is assumed that the “input mode change key” is used also as a normal key performing a toggle operation.

The main control unit 160 controls the timer monitoring unit 161 at this time to monitor the depression time of the input mode change key (step S402). The input mode judging unit 162 judges “long depression” in for example a case of continuous depression for 600 ms or more, while judges “short depression” in a case of not more than 600 ms, and supplies that information to the main control unit 160.

Here, in the case of the judgment of “short depression” (“short depression” at step S402), the main control unit 160 changes the input mode by the toggle operation or the list display where a list is displayed on the display unit 14 (step S408).

On the other hand, in the case of the judgment of “long depression” (“long depression” at step S402), the main control unit 160 identifies, via the roaming control unit 163, the country, region, or other area in which the portable terminal device is located at present from the base station ID and other information which can be obtained from the base station 20 (step S403), judges the language effective in the identified area, and decides on the base input mode (step S404).

For example, when it is judged that the area is Japan, the main control unit 160 decides on the base input mode in Japanese, while when it is judged as the U.S., decides on the base input mode in English.

Next, the main control unit 160 reads out the current input mode becoming effective immediately before from the memory 12 (step S405) and compares it with the base input mode decided according to the above description (step S406).

Here, when as a result of the comparison, it is judged that they do not coincide (“no” at step S406), the main control unit 160 changes the base input mode to the decided base input mode and forcibly returns (step S407). Then, it controls the display control unit 165 and displays the characters or symbols input via the operation input unit 13 on the display unit 14 based on the set language. Note that, when it is judged at step S406 that they coincide (“yes” at step S406), it does nothing.

According to the third example of operation described above, by forcibly returning to the preset input mode when long depression of the “input mode change key” is detected, the user convenience is improved. Further, a portable terminal device can be provided in which the display language can be returned to the language at the base input mode by information obtained from the base station 20 and which is excellent in the operability and enables bilingual operation.

Further, the base input mode can be returned to by one touch, therefore the user is released from the stress due to the waiting time, and the usage lifetime of the keys themselves can be extended. Further, the effect that the texting time is shortened is obtained as well.

Fourth Example of Operation

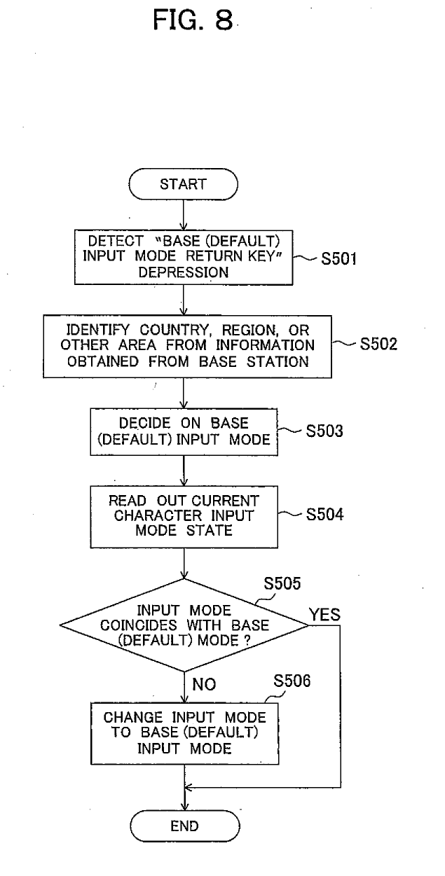

FIG. 8 is a flow chart for explaining a fourth example of operation of a mobile phone constituting a portable terminal device according to an embodiment of the present invention.

Below, the fourth example of operation of the mobile phone 10A constituting the portable terminal device according to the embodiment of the present invention will be explained with reference to the flow chart shown in FIG. 8.

First, assume that the “base input mode return key” assigned as the specific key and arranged in the keys is depressed by the user operating the operation input unit 13 and that the input mode judging unit 162 detects this (step S501). The “base input mode return key” is newly arranged as a dedicated key different from the normal keys performing toggle operations as explained above.

On the other hand, the main control unit 160 identifies, via the roaming control unit 163, the country, region, or other area in which the portable terminal device is located at present from the base station ID and other information which can be obtained from the base station 20 (step S502) and judges the language effective in the identified area and decides on the base input mode (step S503). For example, when it is judged that the area is Japan, the main control unit 160 decides on the base input mode in Japanese, while when it is judged as the U.S., it decides on the base input mode in English.

Next, the main control unit 160 reads out the current input mode becoming effective immediately before (step S504) and compares it with the base input mode decided according to the above description (step S505).

Here, when as a result of the comparison, it is judged that they do not coincide (“no” at step S505), the main control unit 160 changes the base input mode to the decided base input mode and forcibly returns (step S506). Then, it controls the display control unit 165 and displays the characters or symbols input via the operation input unit 13 on the display unit 14 based on the set language. Note that when at step S505 it is judged that they coincide (“yes” at step S505), it does nothing.

According to the fourth example of operation described above, by forcibly returning to the preset input mode when depression of the dedicated “base input mode return key” is detected, the user convenience is improved. Further, a portable terminal device can be provided in which the display language can be automatically return to the language of the base input mode from the information obtained from the base station 20 and which is excellent in the operability and enables bilingual operation.

Further, the base input mode can be return to by one touch, therefore the user is released from the stress due to the waiting time, and the effect that the texting time is shortened is obtained as well.

### INDUSTRIAL CAPABILITY

According to the portable terminal device of the present invention and its input mode control method, it is possible to forcibly return to the preset input mode by a simple operation and the user convenience and operability can be improved, therefore the present portable terminal device and its input mode control, method can be applied to a mobile phone or other portable terminal device.

1. A portable terminal device, comprising:
a specific key,
an operation input unit in which a plurality of types of characters or symbols are assigned to each key and inputting characters or symbols in accordance with the input mode, and
an input mode control unit which forcibly returns to a preset input mode when detecting that the specific key is operated.

2. A portable terminal device as set forth in claim 1, wherein
the terminal device further has a display unit displaying input characters or language, and
the input mode control unit,
when detecting that the specific key is operated, reads out a preset language and decides to return to the input mode, compares the input mode which was effective immediately before the decision and the decided input mode, changes to the decided input mode according to the comparison result, and displays the characters or symbols input in accordance with the input mode on the display unit based on the set language.

3. A portable terminal device as set forth in claim 2, wherein
the terminal device further has a communication unit capable of communicating with a base station, and
the input mode control unit,
when detecting that the specific key is operated, identifies an area to which the terminal device belongs from information acquired from the base station and decides to return to the input mode based on the language effective in the area.

4. A portable terminal, comprising:
a specific key,
an operation input unit in which a plurality of types of characters or symbols are assigned to each key and inputting characters or symbols in accordance with the input mode,
a time monitoring unit monitoring an operating time of the specific key, and
an input mode control unit which forcibly returns to a preset input mode when detecting by the time monitoring unit that the specific key is continuously operated for a predetermined time or more.

5. A portable terminal device as set forth in claim 4, wherein
the terminal device further has a display unit displaying input characters or language, and
the input mode control unit,
when detecting that the specific key is continuously operated for a predetermined time or more, reads out a preset language and decides to return to the input mode, compares the input mode which was effective immediately before the decision and the decided input mode, changes to the decided input mode according to the comparison result, and displays the characters or symbols input in accordance with the input mode on the display unit based on the set language.

6. A portable terminal device as set forth in claim 5, wherein
the terminal device further has a communication unit capable of communicating with a base station, and
the input mode control unit,
when detecting that the specific key is continuously operated for a predetermined time or more, identifies an area to which the terminal device belongs from information acquired from the base station and decides to return to the input mode based on the language effective in the area.

7. A portable terminal as set forth in claim 4, comprising a user interface providing unit displaying a message for variable setting the predetermined time to prompt the user to input the setting, obtaining the setting input by the user, and reflecting it in the monitoring of the time of depression of the specific key.

8. A portable terminal device as set forth in claim 5, comprising a user interface providing unit displaying a message for variable setting the predetermined time to prompt the user to input the setting, obtaining the setting input by the user, and reflecting it in the monitoring of the time of depression of the specific key.

9. A portable terminal device as set forth in claim 6, comprising a user interface providing unit displaying a message for variable setting the predetermined time to prompt the user to input the setting, obtaining the setting input by the user, and reflecting it in the monitoring of the time of depression of the specific key.

10. A portable terminal device, comprising:
a specific key,
an operation input unit in which a plurality of types of characters or symbols are assigned to each key and inputting characters or symbols in accordance with the input mode,
a control unit which monitors the operation of the specific key or the operating time of the specific key and forcibly returns to a preset input mode when detecting the operation of the specific key or detecting that the specific key is continuously operated for a predetermined time or more, and
a display unit displaying the input characters or language, wherein
the control unit displays the input characters or symbols in a preset language or a language effective in the area to which the terminal device belongs.

11. A portable terminal device as set forth in claim 10, wherein
the control unit,
when detecting the operation of the specific key or detecting that the specific key is continuously operated for a predetermined time or more, reads out a preset language and decides return to the input mode, compares the input mode which was effective immediately before the decision and the decided input mode, changes to the decided input mode according to the comparison result, and displays the characters or symbols input in accordance with the input mode on the display unit based on the set language.

12. A portable terminal device as set forth in claim 10, wherein
the terminal device further has a communication unit capable of communicating with a base station, and
the control unit,
when detecting that the specific key is operated or detecting that the specific key is continuously operated for a predetermined time or more, identifies an area to which the terminal device belongs from information acquired from the base station, decides to return to the input mode based on the language effective in the area, and displays the input characters or symbols on the display unit by the language effective in the area to which the terminal device belongs.

13. An input mode control method of a portable terminal device inputting a plurality of types of characters or symbols assigned to each key according to an input mode, comprising:
a first step of monitoring the operation of a specific key or an operating time of the specific key and forcibly returning to a preset input mode when detecting the operation of the specific key or detecting that the specific key is continuously operated for a predetermined time or more and a second step of displaying the input characters or symbols in a preset language or a language effective in the area to which the terminal belongs.

14. An input mode control method of the portable terminal device as set forth in claim 13, wherein:
in the first and second steps, the method,
when detecting the operation of the specific key or detecting that the specific key is continuously operated for a predetermined time or more, reads out a preset language and decides return to the input mode, compares the input mode which was effective immediately before the decision and the decided input mode, changes to the decided input mode according to the comparison result, and displays the characters or symbols input in accordance with the input mode on the display unit based on the set language.

15. An input mode control method of the portable terminal device as set forth in claim 13, wherein:
in the first and second steps, the method,
when detecting that the specific key is operated or detecting that the specific key is continuously operated for a predetermined time or more, identifies an area to which terminal device belongs from information acquired from the base station, decides to return to the input mode based on the language effective in the area, and displays the input characters or symbols on the display unit by the language effective in the area to which the terminal device belongs.
